(19) United States
(12) Patent Application Publication
(10) Pub. No.: US 2026/0361221 A1
(43) Pub. Date: Nov. 12, 2026

(54) A FOUR-PHASE SOFT-SWITCHING BOOST CONVERTER WITH AUXILIARY SWITCH

(71) Applicant: Wayne State University, Detroit, MI (US)

(72) Inventors: Caisheng Wang, Troy, MI (US); Minh Khai Nguyen, Royal Oak, MI (US); XueCheng Tao, Weifang (CN); Fei Wang, Weifang (CN); Youliang Fu, Weifang (CN)

(21) Appl. No.: 19/111,865

(22) PCT Filed: Sep. 15, 2023
(86) PCT No.: PCT/US2023/032924

§ 371 Date: Mar. 14, 2025

Related U.S. Application Data
(60) Provisional application No. 63/407,334, filed on Sep. 16, 2022.

(51) Int. Cl. H02M 3/158; H02M 1/00; H02M 3/00

(52) U.S. Cl. CPC H02M 3/1586; H02M 1/0058; H02M 3/01

(57) ABSTRACT

A circuit comprising a voltage source, a four-phase boost converter, an auxiliary circuit, and a controller is disclosed. The four-phase boost converter includes two loosely coupled inductors, each loosely coupled inductor having one input from the voltage source and two output legs for a total of four output legs. Additionally, each of the four output legs include a respective main circuit diode in series therewith that all pass to a main node, the main node having a common output voltage. The auxiliary circuit can be coupled to the four-phase boost converter; and further, the auxiliary circuit can include a common auxiliary circuit node that is electrically coupled to the main node. Further, the auxiliary circuit can include four auxiliary diodes, each respectively coupled from the common auxiliary circuit node to a respective one of the four output legs.

### CROSS REFERENCE TO RELATED APPLICATION

This application claims the benefit of Applicant's prior provisional application Ser. No. 63/407,334 filed on Sep. 16, 2022, the entire contents of which are incorporated herein by reference.

### TECHNICAL FIELD

The disclosure relates generally to a four-phase soft-switching boost converter with single auxiliary switch that may, for example, be used in connection with vehicles, power systems, and power supplies.

### BACKGROUND

This background description is set forth below for the purpose of providing context only. Therefore, any aspect of this background description, to the extent that it does not otherwise qualify as prior art, is neither expressly nor impliedly admitted as prior art against the instant disclosure.

Some boost converters are complex, do not provide sufficient functionality, do not include enough phases, and/or do not involve turning on and off converter switches at zero voltage switching (ZVS) and zero current switching (ZCS) conditions.

There is a desire for solutions/options that minimize or eliminate one or more challenges or shortcomings of four-phase soft switching boost converters with a single auxiliary switch. The foregoing discussion is intended only to illustrate examples of the present field and is not a disavowal of scope.

### SUMMARY

In embodiments, a circuit can comprise a voltage source, a four-phase boost converter, an auxiliary circuit, and a controller. The four-phase boost converter can include two loosely coupled inductors, each loosely coupled inductor having one input from the voltage source and two output legs for a total of four output legs. Additionally, each of the four output legs can include a respective main circuit diode in series therewith that all pass to a main node, the main node having a common output voltage. The auxiliary circuit can be coupled to the four-phase boost converter; and further, the auxiliary circuit can include a common auxiliary circuit node that is electrically coupled to the main node. Further, the auxiliary circuit can include four auxiliary diodes, each respectively coupled from the common auxiliary circuit node to a respective one of the four output legs. The auxiliary circuit includes one auxiliary switch coupled to the common auxiliary circuit node and to ground. The circuit can include a controller that is coupled to each of the four main circuit switches and to the one auxiliary switch. The controller can is configured to close the one auxiliary switch before each one of the four main circuit switches is closed.

In embodiments, the four main circuit switches can comprise a first main switch, a second main switch, a third main switch, and a fourth main switch; and the controller can be configured to close the first main switch when the fourth main switch is closed, the second main switch is open, and the third main switch is open. Further, the controller can be configured to close the third main switch when the first main switch is closed. The controller can be configured to close the second main switch when the third main switch is closed and the first main switch and the third main switch are open.

With embodiments, the auxiliary circuit can include a resonant inductor couped to one or more outputs of each of the four auxiliary diodes. Additionally, the auxiliary circuit can comprise a resonant capacitor coupled to the one or more outputs of each of the four auxiliary diodes. A resonant diode can be coupled between the resonant inductor and the resonant capacitor; and in further embodiments, the resonant inductor and the resonant diode can be coupled with the one auxiliary switch. A fifth auxiliary diode can be coupled to the resonant capacitor and the resonant diode.

In embodiments, the four-phase boost converter and the auxiliary circuit can be formed as an integrated circuit, and in other embodiments, the four-phase boost converter, the auxiliary circuit, and the controller can be formed as an integrated circuit. The one auxiliary switch can be turned off at zero voltage switching (ZVS) conditions, and the one auxiliary switch can be turned on at zero current switching (ZCS) conditions. With examples, the controller can be configured to turn on and off the four main circuit switches under soft-switching conditions via the one auxiliary switch.

The foregoing and other potential aspects, features, details, utilities, and/or advantages of examples/embodiments of the present disclosure will be apparent from reading the following description, and from reviewing the accompanying drawings.

### BRIEF DESCRIPTION OF THE DRAWINGS

While the claims are not limited to a specific illustration, an appreciation of various aspects may be gained through a discussion of various examples. The drawings are not necessarily to scale, and certain features may be exaggerated or hidden to better illustrate and explain an innovative aspect of an example. Further, the exemplary illustrations described herein are not exhaustive or otherwise limiting, and are not restricted to the precise form and configuration shown in the drawings or disclosed in the following detailed description. Exemplary illustrations are described in detail by referring to the drawings as follows:

FIG. 1 is an illustration of the disclosed circuit topology, showing an auxiliary circuit, a four-phase boost converter, and a controller, in accordance with the various disclosed embodiments.

FIG. 2 is an illustration of the disclosed circuit topology, including two four-phase boost converters, each having an associated auxiliary circuit connected with a single controller, in accordance with the various disclosed embodiments.

FIG. 3 is an illustration of various waveforms resulting from operation of the circuit, in accordance with the various disclosed embodiments.

FIG. 4 is an illustration of various resulting circuits (a)-(j) resulting from operation of the auxiliary switch and four main switches: Equivalent circuits: (a) Stage 0, (b) stage 1 [t1, t2], (c) stage 2 [t2, t3], (d) stage 3 [t3, t4], (e) stage 4 [t4, t5], (f) stage 5 [t5, t6], (g) stage 6 [t6, t7], (h) stage 7 [t7, t8], (i) stage 8 [t8, t9], and (j) stage 9 [t9, t10], are shown in accordance with the various disclosed embodiments.

FIG. 5A is an illustration of simulation results at D=0.3 of the proposed circuit, in accordance with the various disclosed embodiments.

FIG. 5B is a close up view of a portion of the simulation results at D=0.3 of the proposed circuit, in accordance with the various disclosed embodiments.

FIG. 6A is an illustration of simulation results at D=0.3 of the proposed circuit, in accordance with the various disclosed embodiments.

FIG. 6B is a close up view of a portion of the simulation results at D=0.3 of the proposed circuit, in accordance with the various disclosed embodiments.

FIG. 7 is an illustration of experimental results at 4.23 kW and D=0.3 of the proposed circuit, in accordance with the various disclosed embodiments.

FIG. 8 is an illustration of experimental results at 10.24 kW and D=0.55 of the proposed circuit, in accordance with the various disclosed embodiments.

### DETAILED DESCRIPTION

Referring now to the discussion that follows and the drawings, illustrative approaches to the disclosed systems and methods are described in detail. Although the drawings represent some possible approaches, the drawings are not necessarily to scale and certain features may be exaggerated, removed, or partially sectioned to better illustrate and explain the present disclosure. Further, the descriptions set forth herein are not intended to be exhaustive, otherwise limit, or restrict the claims to the precise forms and configurations shown in the drawings and disclosed in the following detailed description.

DC-DC converters are widely used in many industry applications, where a low voltage is boosted to a high DC-bus voltage. Multiphase converters can be suitable for high power applications. Further, to reduce the switching loss, soft-switching techniques are applied to the boost converter. The proposed four-phase soft-switching boost converter can reduce the number of components, which further results in a reduction of size and cost for the converter. Overall, the proposed four-phase soft-switching boost converter can bring in new applications, for example, high-power multiphase converters.

With embodiments, the proposed four-phase soft-switching boost converter reduces the number of power devices while maintaining the soft switching of the switches. When compared with the conventional soft-switching boost converter, the proposed four-phase soft-switching saves at least three power switches, three resonant inductors, three resonant capacitors, and two power diodes (resulting in reduced cost and volume). Higher power density could be achieved as well.

In recent years, multiphase interleaved boost DC-DC converters have been adopted for high-power fuel cell vehicles and renewable energy applications. To reduce the switching loss and electromagnetic interference (EMI), soft-switching techniques with the passive and active snubber circuits are usually applied. A passive snubber-based soft-switching boost converter employs diodes, capacitors, and inductors to turn the main switch on at ZCS and off at ZVS conditions. The major limitations of the passive snubber-based soft-switching converters include the high voltage and current stresses on the components. Active snubber based soft-switching boost converters use an auxiliary switch to achieve a wide range of soft switching. A comprehensive comparison between two soft-switching interleaved converters with and without using the third diode in the auxiliary circuit is presented. For multiphase converters, the snubber is normally used in each phase. Consequently, the size and cost of the multiphase soft-switching converter are increased.

To reduce the size and cost of the converter, one snubber is applied to two phases is known. A two-phase soft-switching boost converter with a duty cycle greater than 0.5 is known. However, the soft-switching feature of this converter is lost when the duty cycle is less than 0.5. And, only the simulation results are provided in this work. A known active snubber cell includes one switch, (N+2) diodes, two inductors, and one capacitor is employed to an N-phase boost converter.

Nevertheless, the experimental results only show the two-phase boost converter. In fact, the operating principle of the soft-switching converter with a common snubber is slightly different when the number of phases is more than 2.

A four-phase soft-switching boost converter is disclosed using only one switch in the auxiliary circuit is presented. The soft-switching range of the four-phase boost converter is extended, and the experimental results are provided. Analysis, operating stages, and simulation result of the four-phase converter are presented. A 10-kW prototype of the proposed converter is built and tested.

### Four-Phase Soft-Switching Boost Converter with a Single Auxiliary Switch

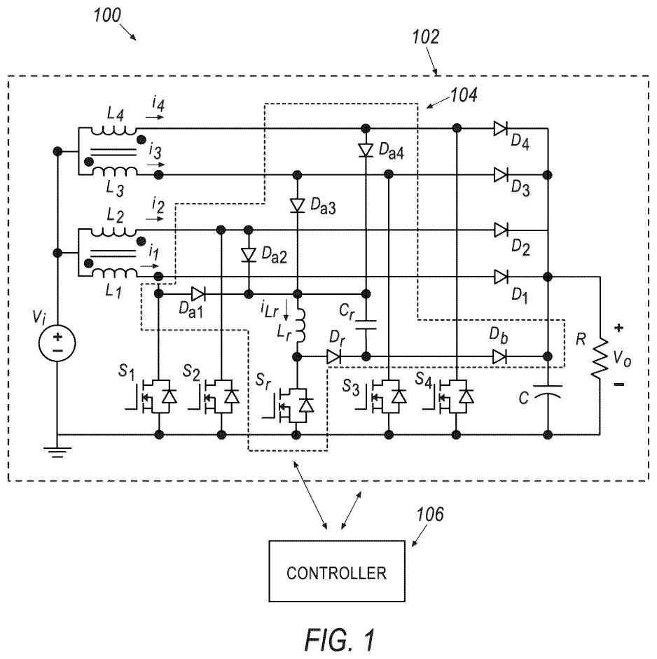

With embodiments, such as generally illustrated in FIG. 1, the proposed circuit 100 (e.g., the four-phase soft-switching boost converter) includes a four-phase boost converter 102, an auxiliary circuit 104 coupled to the four-phase boost converter 102, and a controller 106 coupled to both the four-phase boost converter 102 and the auxiliary circuit 104. The controller 106 can be configured to operate the four-phase boost converter 102 and the auxiliary circuit 104 (as well as switches, diodes, and other components contained therein). In examples, the four-phase boost converter 102, the auxiliary circuit 104, and/or the controller 106 can be formed as an integrated circuit.

In embodiments, the proposed circuit 100 includes a single auxiliary switch (Sᵣ). Additionally, the proposed circuit 100 includes a four-phase boost converter 102, which can be a conventional coupled-inductor based four-phase interleaved boost converter. As can be seen in FIG. 1, the four-phase boost converter 102 includes two loosely coupled inductors (L₁, L₂ and L₃, L₄), four main switches (S₁, S₂, S₃, and S₄), and four diodes (D₁, D₂, D₃, and D₄). Unlike conventional soft-switching converters, the proposed circuit 100 uses only one auxiliary switch (Sᵣ) to turn on and off the four main switches (S₁, S₂, S₃, and S₄).

With embodiments, the auxiliary circuit 104 can include any number of configurations. For example and without limitation, the auxiliary circuit 104 includes six diodes (Dₐ₁, Dₐ₂, Dₐ₃, Dₐ₄, Dᵣ, D_{b}), the auxiliary switch (Sᵣ), a resonant inductor (Lᵣ), and a resonant capacitor (Cᵣ). The controller 106 can facilitate switching of the auxiliary switch (Sᵣ) and the four main switches (S₁, S₂, S₃, and S₄) under soft-switching conditions.

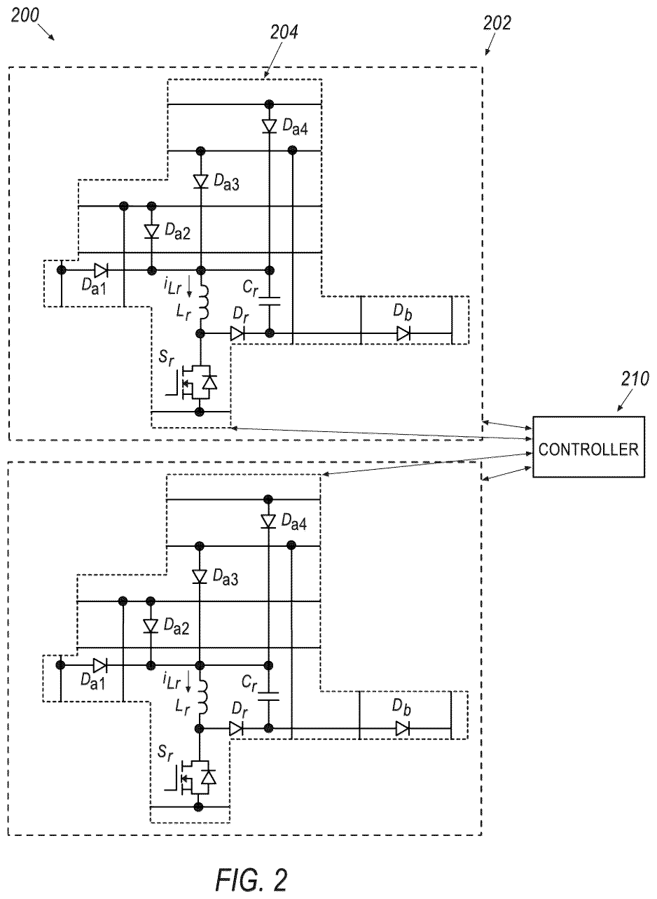

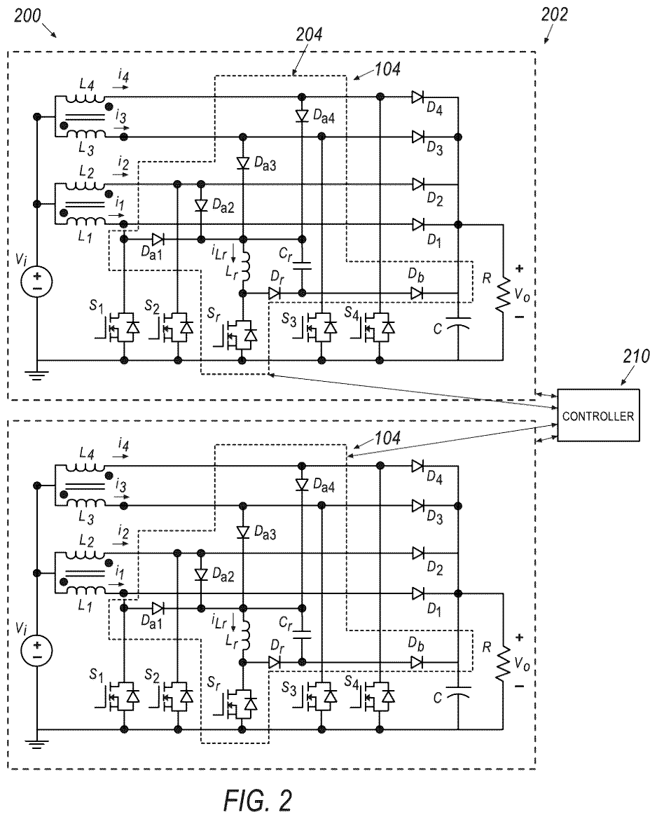

With embodiments, such as generally illustrated in FIG. 2, the proposed circuit 200 can include any number of four-phase boost converters (202, 206) connected with associated auxiliary circuits (204, 208) to generate more than 4 phases. A controller 210 can be connected/coupled to a first four-phase boost converter 202, a first auxiliary circuit 204 (associated with the first four-phase boost converter 202), a second four-phase boost converter 206, and a second auxiliary circuit 208 (associated with the second four-phase boost-converter 206). The controller 210 can be connected to any number of four-phase boost converters and auxiliary circuits to generate any degree/factor/multiple of four phases.

### Operating Stages 0-9

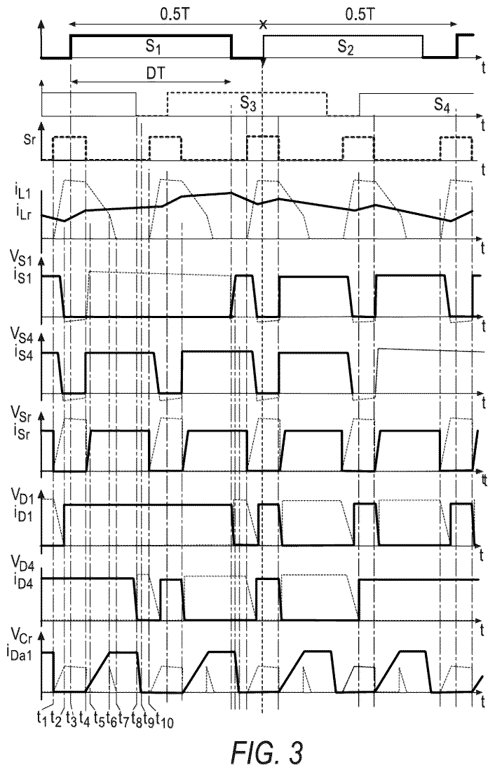

With embodiments, such as generally illustrated in FIG. 3, one or more various key waveforms are generated by the proposed circuit 100. For example, the duty cycle of the auxiliary switch (Sᵣ) is assumed to be larger than 0.25 so at least one of the four main switches (S₁, S₂, S₃, and S₄) is turned on during a switching period. Before to, main switch S₄ is on, while other main switches (S₁, S₂, S₃) are off. Further, before to, main circuit diodes D₁-D₃ are on, whereas other diodes of the proposed circuit 100 are off. At this time, inductor L₄ stores energy. Such as can be seen in FIG. 3, Stage 0 of the proposed circuit 100 is illustrated as resulting circuit (a).

In embodiments, FIG. 3 illustrates various solid and dashed waveforms. Accordingly, the dashed waveforms represent the following currents: i_{Lr}; i_{S1}; i_{S4}; i_{Sr}; i_{D1}; i_{D4}; and i_{Da1}. Further, the solid waveforms represent the following voltages/currents: i_{L1}; v_{S1}; v_{S4}; v_{Sr}; v_{D1}; v_{D4}; and v_{Cr}.

Turning to Stage 1, the time between ty and t₂ is shown in FIG. 3 as resulting circuit (b). At t₁, the auxiliary switch Sᵣ is turned on under ZCS because current i_{Lr} is increased from a zero value. Subsequently, Lᵣ and C_{oss,S1}-C_{oss,S3} start to resonate after main circuit diodes D₁-D₃ are OFF. When i_{Lr}=i_{L1}+i_{L2}+i_{L3}, main circuit diodes D₁-D₃ are reverse-biased at ZCS. The time interval in this stage can be represented as:

$${t}_{2} - {t}_{1} = {L}_{r} \frac{{I}_{L 1} + {I}_{L 2} + {I}_{L 3}}{{V}_{o}} \qquad ( 1 )$$

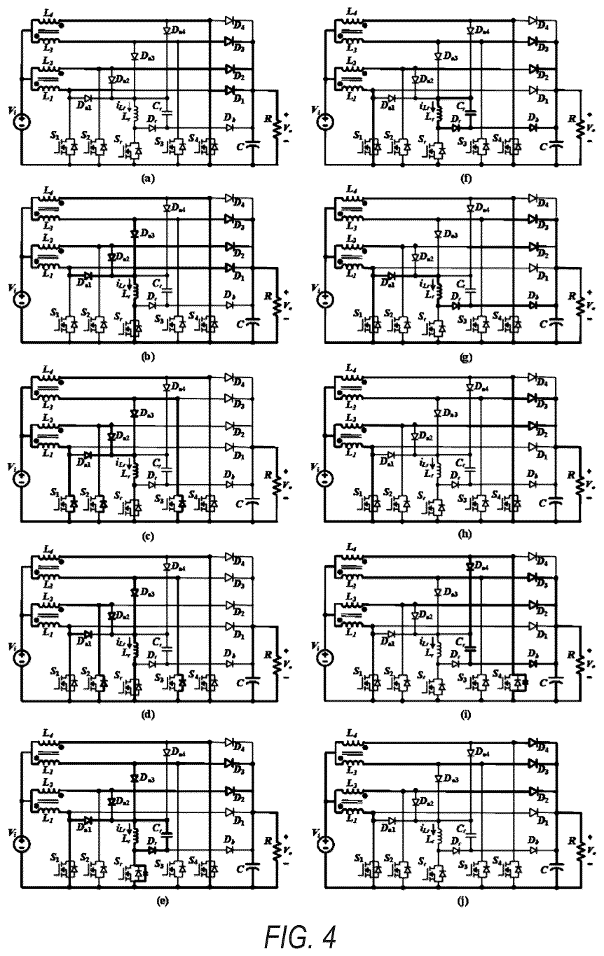

With embodiments, such as generally illustrated in FIG. 3, the time between t₂ and t₃ (Stage 2) is illustrated as resulting circuit (c), shown in FIG. 4. As can be seen from the resulting waveforms, when C_{oss,S1}-C_{oss,S3} is completely discharged, the voltage across C_{oss,S1}-C_{oss,S3} is zero, while the Lᵣ₁ current is equal to the peak value at t₂. As such, currently, the body diodes (shown as part of each of the four main switches) of S₁-S₃ start to conduct, and their voltages are proximately zero. At this moment, main switches S₁-S₃ are ready to turn on under ZVS condition.

Turning next to Stage 3, the time between t₃ and t₄ is shown in FIG. 3 as resulting circuit (d), shown in FIG. 4. As can be seen from the resulting waveforms, at t₃, S₁ is turned ON under ZVS condition. Because auxiliary switch Sᵣ is still on, it carries the boost inductor's current. Additionally, trivial circulating currents can flow to the main switches.

Turning next to Stage 4, the time between t₄ and t₅ is shown in FIG. 3 as resulting circuit (e), shown in FIG. 4. As can be seen from the resulting waveforms, at t₄, auxiliary switch Sᵣ is turned off with ZVS condition, whereas main switches S₁ and S₄ are turned on; main switches S₂ and S₃ are still off. Resonant inductor Lᵣ transfers its stored energy to resonant capacitor Cᵣ through a resonant diode Dᵣ and C_{oss,Sr} through main switch S₁. At the end of this mode, the auxiliary switch Sᵣ voltage is equal to the output voltage.

Turning next to Stage 5, the time between t₅ and to is shown in FIG. 3 as resulting circuit (f), shown in FIG. 4. As can be seen from the resulting waveforms, when the auxiliary switch Sᵣ voltage is equal to the output voltage, auxiliary diodes Dₐ₁-Dₐ₃ are reverse-biased, while main circuit diodes D₂, D₃, Dᵣ, and D_{b} are forward-biased. Resonant inductor Lᵣ still transfers its stored energy to resonant capacitor Cᵣ through Dᵣ. This stage ends when the resonant capacitor Cᵣ voltage is equal to the output voltage. The time interval in stages 4 and 5 is calculated as (1), where C_{eq}=Cᵣ₁+C_{oss,Sr},

$${t}_{6} - {t}_{4} = \sqrt{{L}_{r} {C}_{eq}} {sin}^{- 1} ( \frac{{V}_{o}}{{I}_{Lr , peak} \sqrt{{L}_{r} / {C}_{eq}}} ) \qquad ( 2 )$$

Turning next to Stage 6, the time between t₆ and t₇ is shown in FIG. 3 as resulting circuit (g), shown in FIG. 4. As can be seen from the resulting waveforms, when the resonant capacitor Cᵣ voltage is equal to the output voltage, auxiliary diodes Dₐ₁ and D₁ are forward-biased. The remaining energy of the resonant inductor Lᵣ is transferred to the load, and its current goes to zero.

Turning next to Stage 7, the time between t₇ and t₅ is shown in FIG. 3 as resulting circuit (h), shown in FIG. 4. Main switches S₁ and S₄ are turned on, whereas main switches S₂ and S₃ are turned off. Inductors L₁ and L₄ store the energy while inductors L₂ and L₃ transfer the energy from the source to the load.

Turning next to Stage 8, the time between t₈ and t₉ is shown in FIG. 3 as resulting circuit (i), shown in FIG. 4. As can be seen from the resulting waveforms, at t₈, main switch S₄ is turned off with ZVS condition. Auxiliary diodes Dₐ₄ and D_{b} are forward-biased. Resonant (e.g., snubber) capacitor Cᵣ is discharged, while parasitic capacitor of S₄, C_{oss,S4}, is charged.

Turning next to Stage 9, the time between t₆ and t₁₀ is shown in FIG. 3 as resulting circuit (j), shown in FIG. 4. As can be seen from the resulting waveforms, at to, main diode D₄ is forward-biased to transfer the inductor L₄ energy to the load. Stage 9 will end when auxiliary switch Sᵣ is turned on again. Then, the converter changes the on state from main switch S₄ to main switch S₁; the sequence of the stages is similar as presented above.

Turning next to subsequent stages occurring after Stage 9 (which can generally be seen in FIG. 3 in the waveforms occurring after t₁₀), when main switch S₁ is turned on, the inductor L₁ current (i₁) is increasing. When the main switch S₁ is turned off, inductor current (i₁) is decreasing. Similarly, when main switch S₂ is turned on, inductor L₂ current i₂ is increasing. When main switch S₂ is turned off, i₂ is decreasing. Additionally, when main switch S₃ is turned on, inductor L₃ current i₃ is increasing. When main switch S₃ is turned off, i₃ is decreasing. When main switch S₄ is turned on, inductor L₄ current i₄ is increasing. When main switch S₄ is turned off, i₄ is decreasing. Thus, the waveforms of current of inductors L₂, L₃ and L₄ are similar to i₁, but have a phase-shift of 90 degree each other. After one switching period, these waveforms are repeated frequently.

### Resonant Parameter Guideline

Capacitance and inductance in the resonant tank of the auxiliary circuit 104 are selected as follows. To achieve ZCV turn-off main switches, the resonant capacitor voltage needs to be equal to the output voltage after stage 5. Then, all stored energy of the resonant inductor is fully transferred to the resonant capacitor:

$${C}_{r} < {{L}_{r} ( \frac{3 {I}_{L , peak}}{{V}_{o}} )}^{2} \qquad ( 3 )$$

Further, to achieve ZVS turn-on main switches, the auxiliary switch Sᵣ should be turned on before the main switch (e.g., any of the four main switches) is turned on by an interval more than a mode 1 interval (corresponding to the first duty cycle). The resonant inductor is obtained by deriving (1) as:

$${L}_{r} < \frac{{V}_{o}}{3 {I}_{L}} ( {t}_{2} - {t}_{1} ) , \qquad ( 4 )$$

where I_{L}=I_{L1}=I_{L2}=I_{L3}.

### Comparison Study

Table I shows a comparison between the proposed converter 100 and the other multiphase soft-switching converters with one auxiliary circuit. As shown in FIG. 1 with one auxiliary circuit 104, the proposed converter has four-phase operation, while other converters only have two-phase operation. The main switches of the proposed converter and the converters in [8], [9] are turned on and off at ZVS condition, while the auxiliary switch is turned on at ZCS and off at ZVS. The operating duty cycle for soft switching of the proposed converter is larger than other converters. Moreover, the proposed converter is tested at high power, and the measured efficiency is the highest among the compared converters.

TABLE I
COMPARISON BETWEEN PROPOSED CONVERTER AND OTHER MULTI-PHASE
SOFT-SWITCHING CONVERTERS WITH ONE AUXILIARY CIRCUIT

| | Converter in [7] | Converter in [8] | Converter in [9] | Proposed Converter |
|---|---|---|---|---|
| Auxiliary | 1Sw and 1L | 1Sw, 1L, | 1Sw, 2L, | 1Sw, 1L, |
| Circuit | | 1C, and 4D | 1C, and 4D | 1C, and 6D |
| Phase number | Two | Two | Two | Four |
| per auxiliary | | | | |
| circuit | | | | |
| Main Switches | ZVT turn-on | ZVS | ZVS | ZVS |
| | Near ZCS | turn-on/off | turn-on/off | turn-on/off |
| | turn-off | | | |
| Auxiliary | ZCS turn-on | ZCS turn-on | ZCS turn-on | ZCS turn-on |
| Switch | Near ZCS | ZVS turn-off | ZVS turn-off | ZVS turn-off |
| | turn-off | | | |
| Soft-switching | D < 0.6 | D > 0.5 | D > 0.5 | D > 0.25 |
| range | | | | |
| Spec | 500 W, 100 Vin, | 30 kW(*), 226 Vin, | 2 kW, 180 Vin, | 10 kW, 200 Vin, |
| | 250 Vout, 50 kHz, | 800 Vout, 100 kHz | 400 Vout, 50 kHz, | 524 Vout, 50 kHz, |
| | 95.12% | | 97.9% | 98.62% |

(*)Simulation only, no efficiency data.

### Simulation and Experimental Results

To verify the operating principle of the proposed circuit 100 (e.g., four-phase soft-switching boost converter 102 with a single auxiliary switch 104), a 10-kW prototype has been built and tested. LTSpice simulation results are also provided where the input voltage is 200 V. Two coupled inductors with a self-inductance of 250 μH and a coupling coefficient of 0.7 were used for the four-phase converter. The resonant inductor and capacitor were selected as 5 H and 10 nF, respectively. Five SiC UF3C120040K4S MOSFET switches and ten UJ3D1250K2 diodes from UnitedSiC were employed. The switching frequency of the main switches is 50 kHz, while the switching frequency of the auxiliary switch is 200 kHz. The resistive load of 27Ω is used.

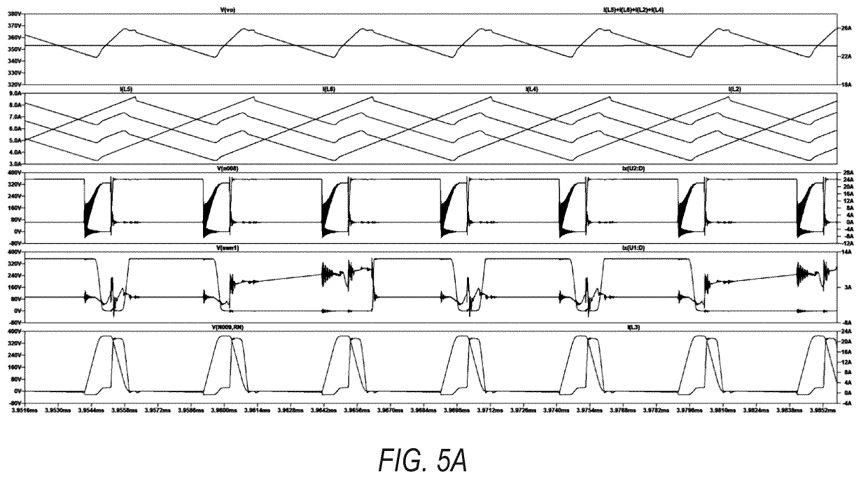

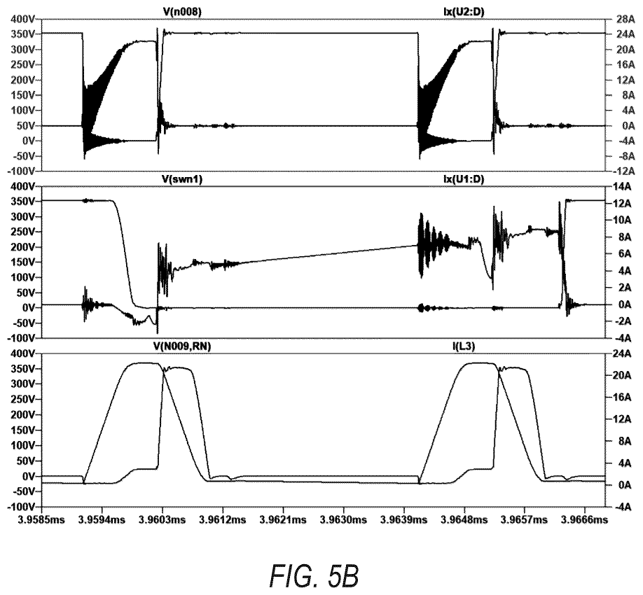

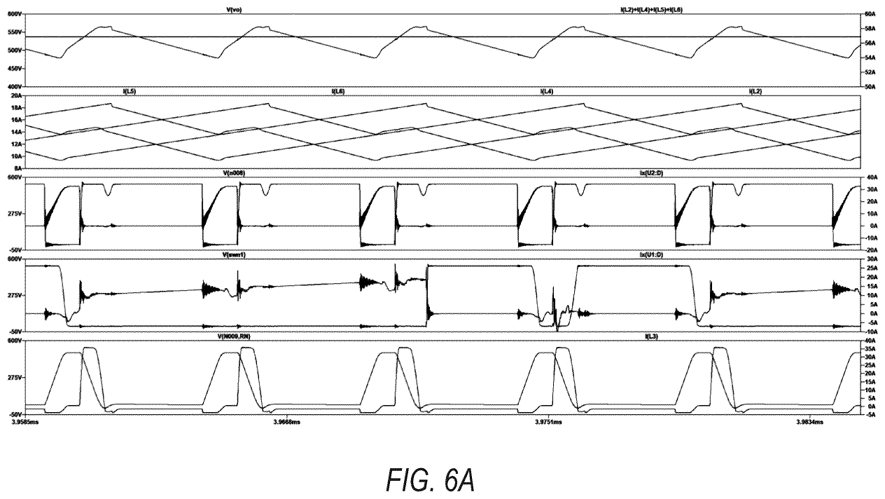

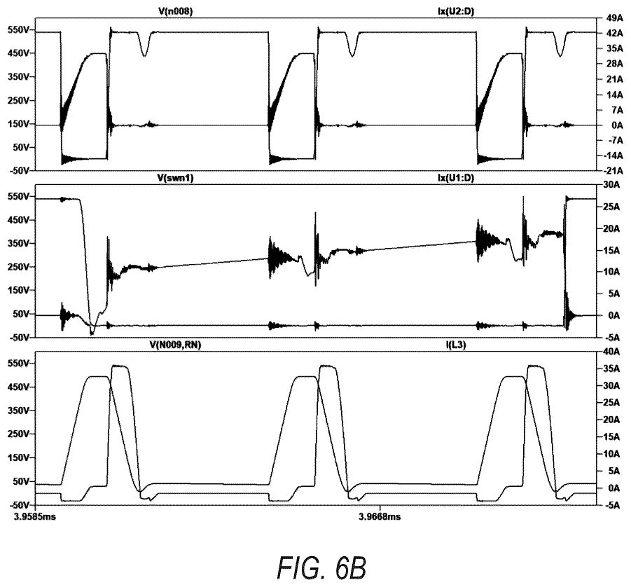

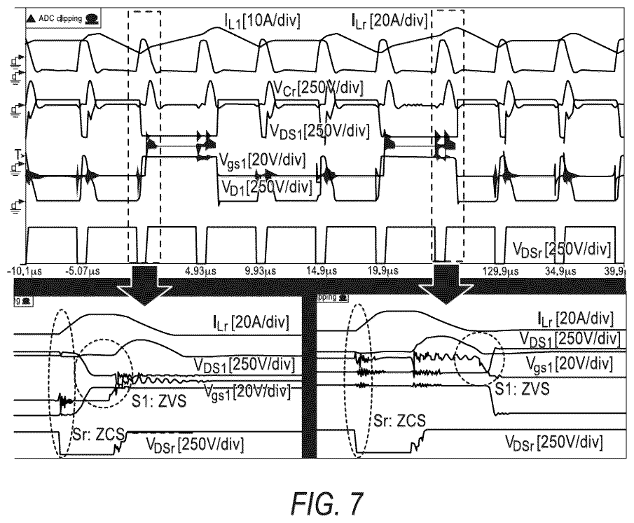

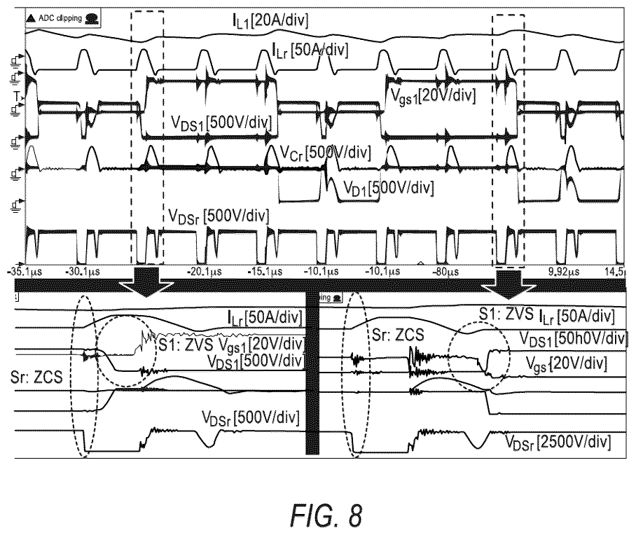

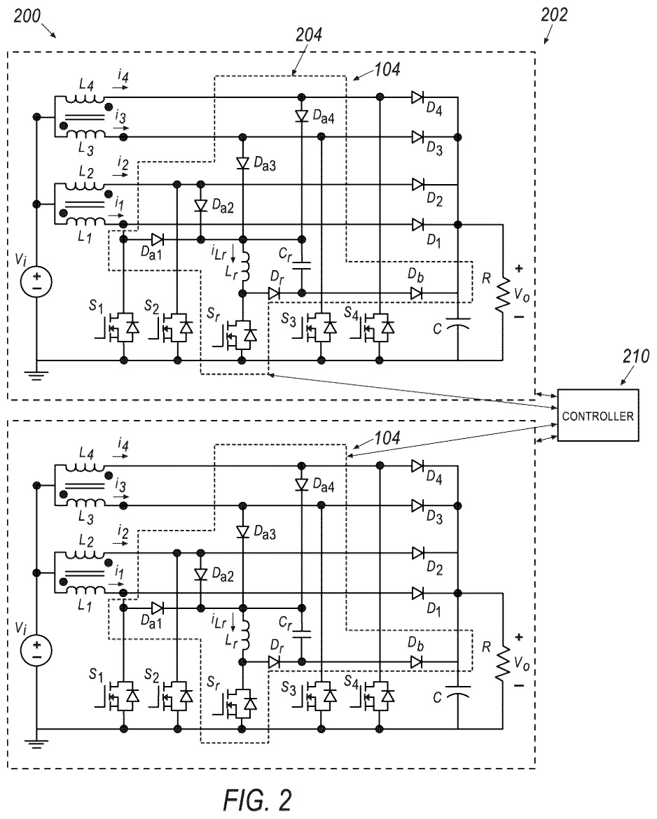

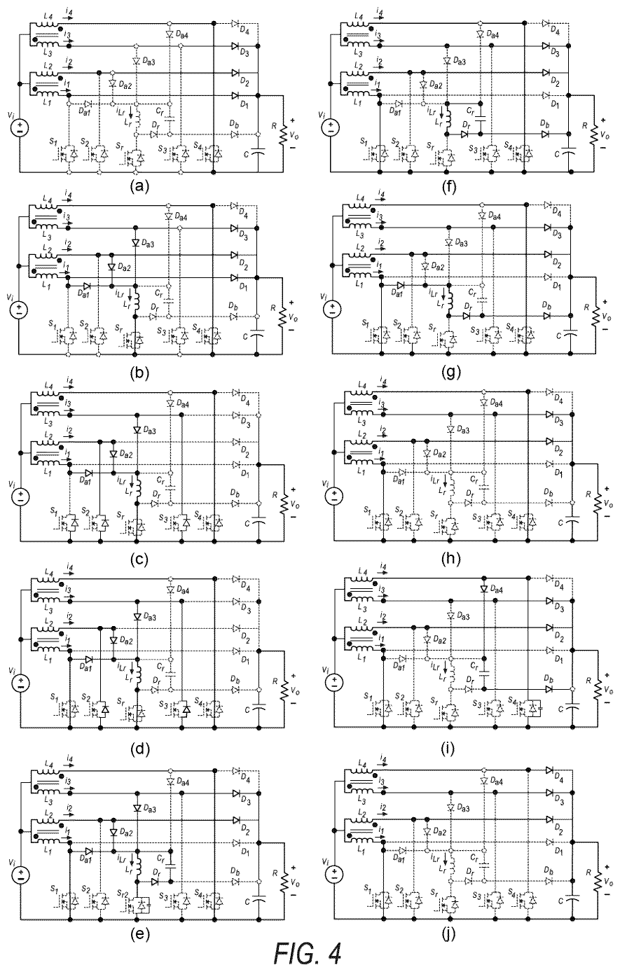

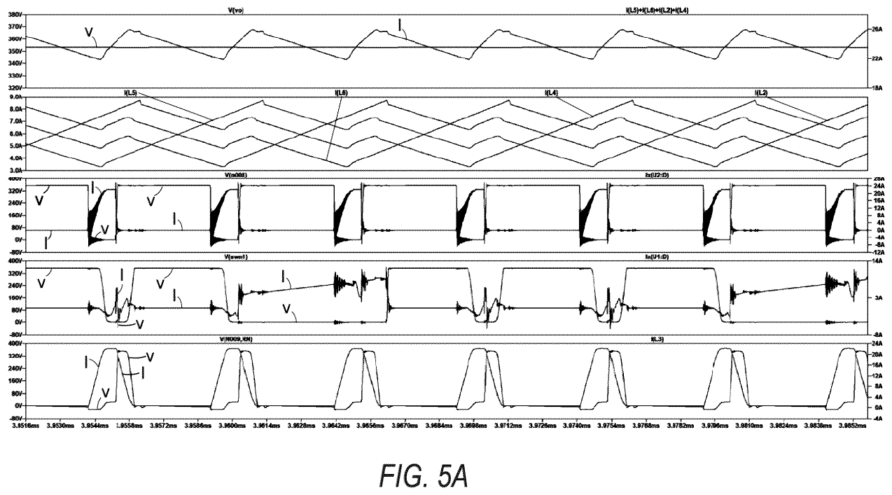

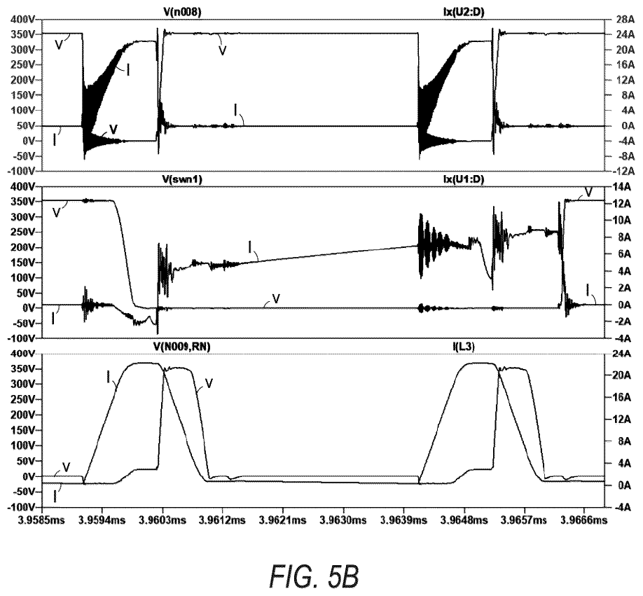

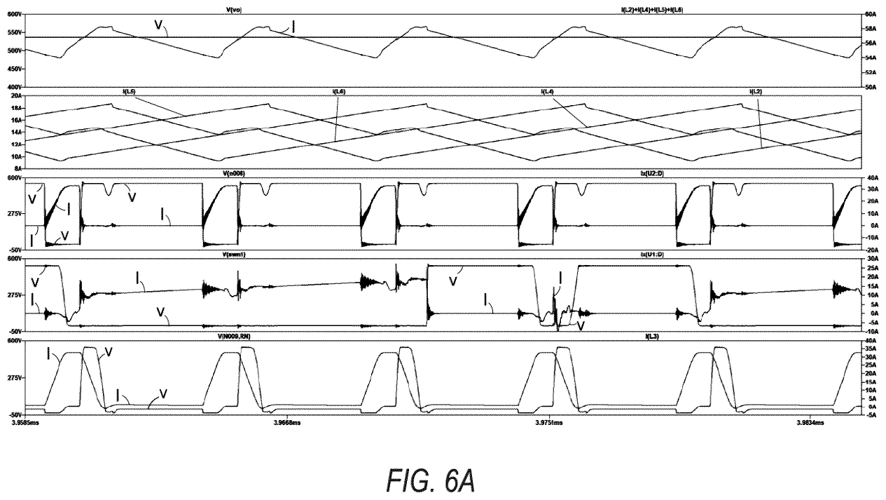

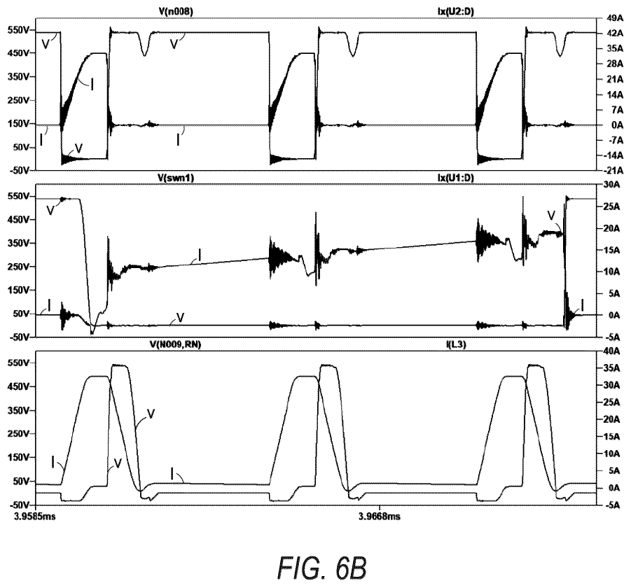

FIGS. 5A, 5B and 6A, 6B show the simulation waveforms of the proposed circuit 100 when the duty cycle of the main switches, D, is 0.3 and 0.55, respectively. The waveforms from top to bottom of FIGS. 5A and 5B are the output voltage and total input inductor current, four inductor currents, voltage and current of the auxiliary switch, voltage and current of the main S₁ switch, and resonant inductor current and resonant capacitor voltage. FIGS. 5B and 6B illustrate the zoomed in view of voltage and current of the auxiliary switch, voltage and current of the main S₁ switch, and resonant inductor current and resonant capacitor voltage. The output voltage is boost from 200 V to 353 V and 537 V at D=0.3 and 0.55, respectively. The main switch is turned on and off at ZVS condition.

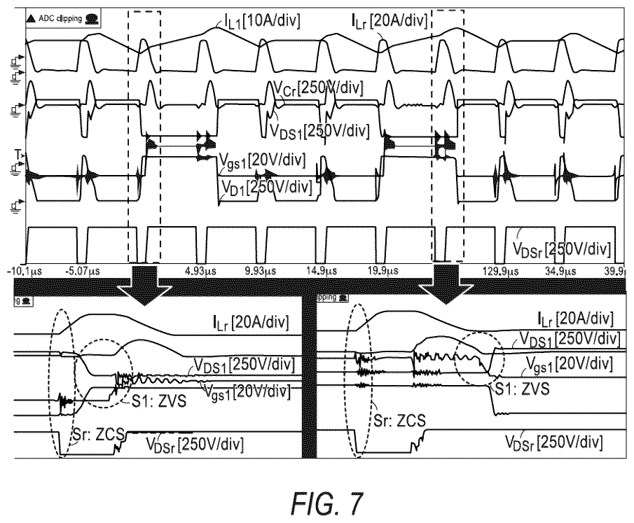

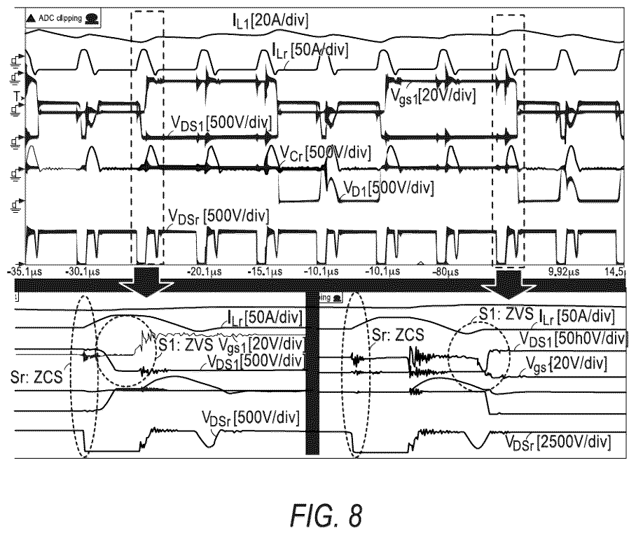

FIGS. 7 and 8 show the experimental waveforms of the proposed converter when the duty cycle of the main switches, D, is 0.3 and 0.55, respectively. The duty cycle of the auxiliary switch is fixed at 0.3 based on the switching frequency of 200 kHz to ensure the auxiliary switch is turned on before the main switch at a time interval of 0.75 μs. When D=0.3, the measured output voltage is boosted to 337 V, whereas it is 524 V when D=0.55. Note that the turn-on time interval of the auxiliary switch also contributes to the voltage gain. It can be seen in the experimental waveforms that the inductor current is increased when the auxiliary switch is turned on. As shown in FIGS. 7 and 8, the auxiliary switch is turned on at ZCS condition and off at ZVS condition. The main switch in phase 1 is turned on and off at ZVS condition. The measured efficiency of the four-phase soft-switching converter is 98.73% at 4.23 kW, D=0.3 and 98.62% at 10.24 kW, D=0.55.

The results show that the main switches of the converter are turned on/off at ZVS condition, while the auxiliary switch is turned on at ZCS and off at ZVS conditions. Analysis, operating stages, and parameter selection are presented. Simulation and experimental results at 10 kW are shown to validate the operating principle of the proposed converter.

The four-phase soft-switching boost converter has a low component count in the auxiliary circuit. The main switches of the converter are turned on and off at ZVS conditions, while the auxiliary switch is turned on at ZCS and off at ZVS conditions. As a result, the efficiency of the proposed circuit 100 is improved, and low electromagnetic interference (EMI) can be achieved. It can be expected to be used in high-power applications, such as fuel cell electric vehicles, renewable energy systems, data center applications, battery charging and management, renewable energy integration, uninterruptable power supplies, PV power generations, and PFC systems.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. The use of “e.g.” in the specification is to be construed broadly and is used to provide non-limiting examples of embodiments of the disclosure, and the disclosure is not limited to such examples. Uses of “and” and “or” are to be construed broadly (e.g., to be treated as “and/or”). For example and without limitation, uses of “and” do not necessarily require all elements or features listed, and uses of “or” are inclusive unless such a construction would be illogical.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

All matter contained in the above description or shown in the accompanying drawings shall be interpreted as illustrative only and not limiting. Changes in detail or structure may be made without departing from the present disclosure.

When introducing elements of various embodiments of the disclosed materials, the articles “a,” “an,” “the,” and “said” are intended to mean that there are one or more of the elements. The terms “comprising,” “including,” and “having” are intended to be inclusive and mean that there may be additional elements other than the listed elements. Furthermore, any numerical examples in the following discussion are intended to be non-limiting, and thus additional numerical values, ranges, and percentages are within the scope of the disclosed embodiments.

While the preceding discussion is generally provided in the context of a material used in connection with vehicles, it should be appreciated that the present techniques are not limited to such limited contexts. The provision of examples and explanations in such a context is to facilitate explanation by providing instances of implementations and applications. The disclosed approaches may also be utilized in other contexts or configurations.

While the disclosed materials have been described in detail in connection with only a limited number of embodiments, it should be readily understood that the embodiments are not limited to such disclosed embodiments. Rather, that disclosed can be modified to incorporate any number of variations, alterations, substitutions or equivalent arrangements not heretofore described, but which are commensurate with the spirit and scope of the disclosed materials. Additionally, while various embodiments have been described, it is to be understood that disclosed aspects may include only some of the described embodiments. Accordingly, that disclosed is not to be seen as limited by the foregoing description, but is only limited by the scope of the appended claims.

What is claimed is:

1. A circuit, comprising:
a voltage source;
a four-phase boost converter, including:
two loosely coupled inductors, each loosely coupled inductor having one input from the voltage source and two output legs for a total of four output legs;
each of the four output legs having a respective main circuit diode in series therewith that all pass to a main node, the main node having a common output voltage;
four main circuit switches coupled to each of the four output legs;
an auxiliary circuit coupled to the four-phase boost converter, the auxiliary circuit including:
a common auxiliary circuit node electrically coupled to the main node;
four auxiliary diodes, each respectively coupled from the common auxiliary circuit node to a respective one of the four output legs;
one auxiliary switch coupled to the common auxiliary circuit node and to ground; and
a controller coupled to each of the four main circuit switches and to the one auxiliary switch, the controller configured to close the one auxiliary switch before any one of the four main circuit switches is closed.

2. The circuit of claim 1, wherein the four main circuit switches comprise a first main switch, a second main switch, a third main switch, and a fourth main switch; and the controller is configured to close the first main switch when the fourth main switch is closed, the second switch main switch is open, and the third main switch is open.

3. The circuit of claim 2, wherein the controller is configured to close the third main switch when the first main switch is closed.

4. The circuit of claim 3, wherein the controller is configured to close the second main switch when the third main switch is closed and the first main switch and the third main switch are open.

5. The circuit of claim 1, wherein the auxiliary circuit further comprises a resonant inductor coupled to one or more outputs of each of the four auxiliary diodes.

6. The circuit of claim 5, wherein the auxiliary circuit further comprises a resonant capacitor coupled to the one or more outputs of each of the four auxiliary diodes.

7. The circuit of claim 6, further comprising a resonant diode coupled between the resonant inductor and the resonant capacitor; and the resonant diode and the resonant inductor are coupled with the one auxiliary switch.

8. The circuit of claim 1, wherein the four-phase boost converter and the auxiliary circuit are formed as an integrated circuit.

9. The circuit of claim 1, wherein the one auxiliary switch is turned off at zero voltage switching (ZVS) and on at zero current switching (ZCS) conditions.

10. The circuit of claim 1, wherein the controller is configured to turn on and off the four main circuit switches under soft-switching conditions via the one auxiliary switch.

11. A circuit, comprising:
a voltage source;
a four-phase boost converter having four output legs each coupled to a respective one of four diodes, the four diodes connected to a main node having a common output voltage, each of the four output legs coupled to a common ground via a respective main circuit switch; and
having four main circuit switches coupled to each of the four output legs;
an auxiliary circuit coupled to the four-phase boost converter, the auxiliary circuit including:
a common auxiliary circuit node electrically coupled to the main node;
four auxiliary diodes, each respectively coupled from the common auxiliary circuit node to a respective one of the four output legs;
one auxiliary switch coupled to the common auxiliary circuit node and to ground; and
a controller coupled to each of the four main circuit switches and to the one auxiliary switch, the controller configured to close the one auxiliary switch before any one of the four main circuit switches is closed.

12. The circuit of claim 11, wherein the controller is configured to turn the auxiliary switch off at zero voltage switching (ZVS) and to turn the auxiliary switch on at zero current switching (ZCS) conditions.

13. The circuit of claim 11, wherein the four main switches are configured to turn on and off at ZVS conditions.

14. The circuit of claim 11, wherein the circuit and the four-phase boost converter, the auxiliary circuit, and the controller are formed as an integrated circuit.

15. The circuit of claim 11, wherein the auxiliary circuit, the controller, and the four-phase boost converter are coupled with a second four-phase boost converter, a second auxiliary circuit and the controller to result in an 8-phase soft-switching boost-converter.

16. The circuit of claim 11, wherein a resulting duty cycle of the circuit is between about 0.25 to about 1.

17. The circuit of claim 11, wherein the four main circuit switches comprise a first main switch, a second main switch, a third main switch, and a fourth main switch; and the controller is configured to close the first main switch when the fourth main switch is closed, the second switch main switch is open, and the third main switch is open.

18. The circuit of claim 17, wherein the controller is configured to close the third main switch when the first main switch is closed.

19. The circuit of claim 18, wherein the controller is configured to close the second main switch when the third main switch is closed and the first main switch and the third main switch are open.

20. The circuit of claim 19, wherein the controller is configured to close the fourth main switch when the second main switch is closed and the third main switch and the first main switch are open.
